(19) United States
(12) Patent Application Publication
(10) Pub. No.: US 2009/0259450 A1
(43) Pub. Date: Oct. 15, 2009

(54) PHYSICS-BASED SIMULATION

(76) Inventors: Paul William CLEARY, Burwood East (AU); Soon Hyoung PYO, Daejeon (KR); Mahesh PRAKASH, Balwyn (AU)

Correspondence Address: LADAS & PARRY LLP, 224 SOUTH MICHIGAN AVENUE, SUITE 1600, CHICAGO, IL, 60604, US

(21) Appl. No.: 12/423,154

(22) Filed: Apr. 14, 2009

(30) Foreign Application Priority Data
Apr. 15, 2008 (AU) 2008901852

(51) Int. Cl. G06G 7/48

(52) U.S. Cl. 703/6

(57) ABSTRACT

The invention relates to computer simulation and animation of visual sequences of a physics based system, such as visual sequences of fluids, for use in motion pictures, video games and the like. Simulation branching is effected by making a record of the system state of a first simulation as it exists at a point in time. If the director wishes to change the manner in which the simulated event progresses, a second simulation can be executed using the recorded system state as input conditions for a second simulation. This allows rapid re-execution of a portion of a simulation without requiring lengthy re-simulation of the initial portion of the simulated event which is already thought to be satisfactory. Such branching can also be used to control high resolution of a focus region being a smaller portion of a wider simulated event.

### CROSS-REFERENCE TO RELATED APPLICATIONS

The present application claims priority from Australian Provisional Patent Application No 2008901852 filed on 15 Apr. 2008, the content of which is incorporated herein by reference.

### TECHNICAL FIELD

The present invention relates to computer simulation and animation of visual sequences of a physics based system, such as visual sequences of fluids, for use in motion pictures, video games and the like.

### BACKGROUND OF THE INVENTION

The traditional approach to using simulation as part of the generation of digital effects involves performing sequences of independent simulations based on a set of initial conditions and controls. For each iteration, the simulation generates the scene starting from the provided initial conditions. From one simulation to the next the initial conditions and controls are iteratively refined under the control of the technical director responsible for directing the scene, in an aim to achieve a specific desired visual effect.

Such simulations may be implemented for practically any physics based system, for which equations governing the behaviour of the elements of the system exist and can be solved for the simulated event using a time stepping process. Such systems could comprise fluids, particles, objects, or otherwise.

As an example, in the case of fluid simulation, for the simulation to appear realistic the simulation must numerically solve complicated equations defining fluid behaviour, allowing for variables and parameters such as fluid velocity, fluid density, fluid pressure, fluid viscosity, surface tension, gravity and the coupling of particles and objects to the fluids, and obeying principles such as fluid momentum laws, boundary conditions, fluid incompressibility, and multi-phase flow in the case of immiscible fluids such as air bubbles within the fluid. To allow editorial control of the scene, such simulations generally further allow for and are further complicated by control variables which influence execution of the simulation procedures. Such control variables permit the scene editor to encourage the fluid to behave in a particular way in the resulting scene.

Further, simulation complexity is substantially increased due to the need to approximate the fluid as a finite number of moving discrete particles, from a Lagrangian viewpoint, each of which must obey the above-noted complicated equations. Alternatively, from an Eulerian viewpoint, the need is to model a large number of points in space and determine how fluid characteristics change at that point over time. From either viewpoint, to provide for improved realism of the behaviour of the fluid, and to permit high definition rendering of scenes produced by the simulation, requires that fluid conditions be modelled at a vast number of simulation points.

A normal scene or event usually involves hundreds if not thousands of frames, and the simulation may calculate the change of state in the fluid at a time step which is much smaller than the frame period. Thus, thousands or hundreds of thousands of time steps of the simulation usually must be calculated, for every simulation point.

As a consequence of the large number of simulated points and time steps, the computing power required to execute each simulation can be substantial. Currently, animation houses for motion pictures run such simulations on extremely powerful farms of processors, but still must often wait hours or days for a single event to be simulated. Even for lesser complexity simulations run on single processors simulation development can be laborious.

Moreover, after executing one such simulation, the resulting scene is reviewed by a technical director or the like to see whether a specific desired visual effect has been achieved. If not, the initial conditions and controls are refined by the scene director and a new simulation is executed, with each such simulation iteration requiring hours or days of processing to execute.

Many such simulation iterations can be required because the results of each change in state (initial conditions, boundary conditions or controls) are not known a priori and are not reliably predictable. Due to the complexity of the simulated event there is often no clear rationale for setting many of the parameters at the start of each simulation, or for deciding on the direction or magnitude of changes to parameters when initiating a subsequent simulation iteration. This means that there is no guarantee that results of the next iteration will meet the editor's expectations. The sequence of simulations needed to refine the event to achieve a specific desired effect can involve many iterations. Changed initial conditions can have such an unpredictable effect that some iterations may not even converge to the desired outcome but may worsen the outcome.

A further complication arises for fluids-based simulation, due to the resolution of the executed solution being changed, from lower resolution during draft simulations, to high resolution for a production simulation. That is, animators wish to first develop a simulation at low resolution, which has low cost, and fine tune all the visual features at this low resolution. Then, once the desired visual effect and visual features have been effected in the low resolution simulation, animators wish to repeat the optimised simulation at high resolution suitable for the final product. A problem with this approach is that the course of the simulation often depends sensitively on the resolution. Changing the resolution changes the system behaviour to one that is typically not what the user wanted. This requires fine tuning the visual effects and controls again, at the fine resolution. Most or all of the benefit of using the coarse resolution is lost. This generates significant user frustration and leads to increased costs and time spent creating specific visual effects. Often editors will choose a direct animation approach in preference to a physics based simulation because of the unreliability of the development process.

A further problem in simulations of fluid is that if there are multiple shots within a scene and close up detail is required in some areas, then this typically requires the development of an independent simulation for each angle or shot. This additional simulation substantially increases cost. This can also result in several closely linked shots looking visually inconsistent due to the use of independent simulations which may not portray the event from the different angles in a sufficiently concordant manner.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY OF THE INVENTION

According to a first aspect the present invention provides a method for simulation workflow management, the method comprising:
executing a first simulation;
during the first simulation, making a record of the system state of the first simulation as it exists at a point in time; and
executing a second simulation using at least a portion of the recorded system state as input conditions for the second simulation.

According to a second aspect the present invention provides a computer program element comprising computer program code means to make a computer execute a procedure for simulation workflow management, the computer program element comprising:
computer program code means for executing a first simulation;
computer program code means for, during the first simulation, making a record of the system state of the first simulation as it exists at that point in time; and
computer program code means for executing a second simulation using at least a portion of the recorded system state as input conditions for the second simulation.

Preferably, a record of the system state of the first simulation is made at multiple points in time throughout the simulation for example at regular intervals during the simulation. Each point in time at which a record is made of the system state is referred to herein as a breakpoint.

In some embodiments of the invention a breakpoint of the first simulation may be used to effect branching, whereby at least a portion of the recorded system state and revised user control parameters are used as initial conditions to initiate the second simulation. Such embodiments enable a user to retain a satisfactory initial portion of the first simulation while refining the remaining portion of the event with revised control parameters in the second simulation.

During the second simulation, the method preferably further comprises making a record of the system state of the second simulation as it exists at that point in time. Such embodiments permit multiple breakpoints and multiple branching steps in the simulation workflow process, such that a sequence of frames from an acceptable initial portion of the first simulation may be retained and may be joined into a sequence of frames from an acceptable initial portion of the second simulation, which in turn may join into frames saved from subsequent simulations. In this way the frame sequence of the entire simulated event may be built up from portions of various iterations of the simulation, without requiring that the acceptable initial portion of each simulation be re-executed after it has been generated and determined to be satisfactory.

Additionally or alternatively, in some embodiments of the invention the second simulation may comprise a simulation of a focus region simulation of a portion of a wider event simulated by the first simulation. For example the focus region may portray a part of the scene as if zoomed into by a camera. In such embodiments the record of the system state of the first simulation may be used to generate initial conditions for a simulation of the focus region. The record from the first simulation of the system state in the focus region will be of relatively coarse resolution, and initiating the second simulation of the focus region may effect higher resolution simulation of the focus region. Optionally, user control parameters may also be refined at the time of initiating the focus region simulation.

Where the simulation is of a fluid, the simulated fluid may be water, lava, smoke, fire, sand or the like.

In additional or alternative embodiments of the invention, the breakpoints of a coarse resolution first simulation may be used to provide controlling information to contemporaneous moments in the simulated event during execution of a second high resolution simulation. Thus, according to a third aspect the present invention provides a method for high resolution simulation, the method comprising:
optimising a first physics based simulation carried out at low resolution; and
recording event controlling information at a plurality of points in time throughout the first simulation; and
executing a second simulation at high resolution based on initial conditions of the first simulation, and further based on the contemporaneous controlling information.

Embodiments of the third aspect thus provide for execution of a high resolution simulation to be controlled not only by the same initial conditions as the optimised low resolution simulation, but also to be controlled at points in time throughout the simulation to conform to the low resolution simulation by the controlling information. The third aspect thus provides substantially improved conformance of the evolution of the simulated event when simulated at coarse and fine resolutions.

In embodiments of the third aspect, the controlling information may comprise stored object motion of selected simulated objects in the first simulation, used in the high resolution simulation to specify location and orientation of corresponding moving objects at key moments during the simulated event. Additionally or alternatively, the controlling information may comprise a spatially varying attractor or drag force derived from the first simulation at the selected points in time. Such an attractor or force may then be used in the second simulation to ensure the coarse scale structure of the event is consistent with the first simulation while allowing high resolution simulation of fine detail in the second simulation.

The controlling information may be stored at points in time corresponding to the frame instants, or with increased or decreased regularity.

### BRIEF DESCRIPTION OF THE DRAWINGS

An example of the invention will now be described with reference to the accompanying drawings, in which:

FIG. 1 illustrates recording the system state of a first simulation at points in time throughout execution of the first simulation;

FIG. 2 illustrates branching of the first simulation into multiple branch simulations;

FIG. 3 illustrates simulation branching for a focus region;

FIG. 4 illustrates conversion of a low resolution simulation into a high resolution simulation; and

FIG. 5 illustrates a general-purpose computing device that may be used in an exemplary system for implementing the invention;

### DESCRIPTION OF THE PREFERRED EMBODIMENTS

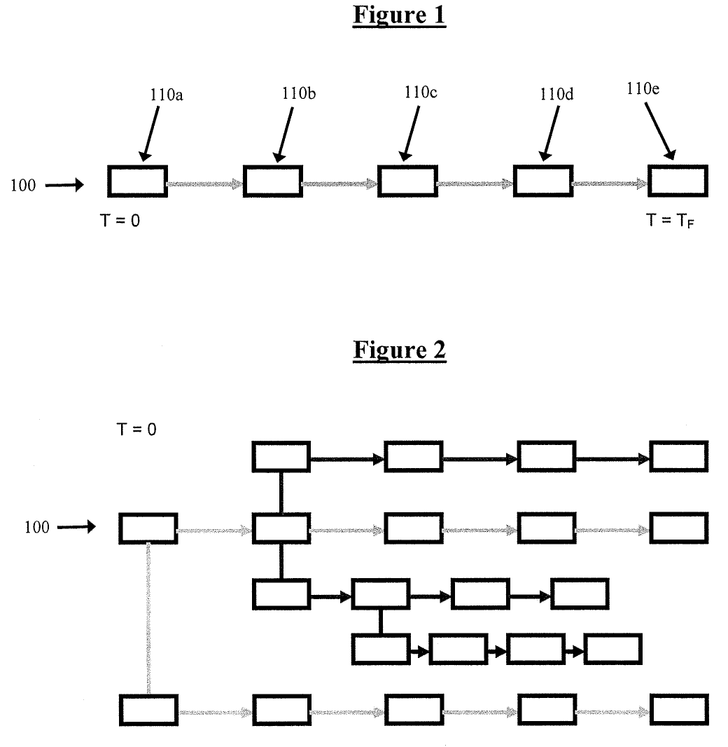

FIG. 1 illustrates recording the system state of a simulation 100 at points in time throughout execution of the simulation. Initially the user runs a base simulation and stores the entire system state periodically during the simulation, as shown at 110a . . . 110e. This allows the simulation to be restarted from any of these stored states, without requiring subsequent iterations to repeat the simulation of the entire event. Restarting simulations is a routine process in simulation processes. The saved system states 110 then allow the user to build and control a branching tree structure of alternative simulations and simulation outputs.

As shown in FIG. 2, the parent simulation 100 can have several branches and sub-branches spread across the duration of the simulated event timeline. The only restriction is that each branch can start only at a recorded system state. As shown in FIG. 2, each branch simulation records systems states throughout execution, which in turn may be used for further sub-branch simulations. The regularity with which system states are captured for a sub-branch need not be the same as the regularity of the root simulation. For example if it is determined that the simulated event is particularly sensitive to changed conditions during a particular stage of the event, then system states may be captured with increased regularity to allow suitable branching opportunities.

A branch can be created in a graphical user interface (GUI) of software implementing the invention by a user selecting a system state and selecting the option to create a branch. The user then has the ability to change any of the control elements of the simulation at this point. The simulation is then re-started from that point with the changed controls and run to the completion point, which may be the same as or different to the completion point of the initial simulation. The GUI interface shows a visual representation of the branched network such as that in FIG. 2, displaying the system states and the connectivity linking them. In the simplest case it would look like a 2 or more pronged fork with the base case having side branches appearing at various states and then continuing on parallel.

Such branching allows the user to run a simulation to see what happens, then to choose points at which they want to vary elements that they want to change but only re-run from the point of the change. Traditional software would require this change to be made at the start of the simulation either by changing the initial simulation controls or by scheduling a control change at selected points of the simulation. Here we explicitly do not re-run the earlier parts of the simulation but use the stored data up to the branch point. This produces a substantial time saving for the user. Branching is hierarchical allowing any degree of refinement of the simulation and allowing savings from not needing to repeat simulations up to each branch point.

To create a final animation sequence the user would select the branch or combination of branches that they want for each section of the event timeline. The sequence of stored data frames from the branches and all its preceding hierarchical parents are then used to construct a single coherent time line of frames for the final animation.

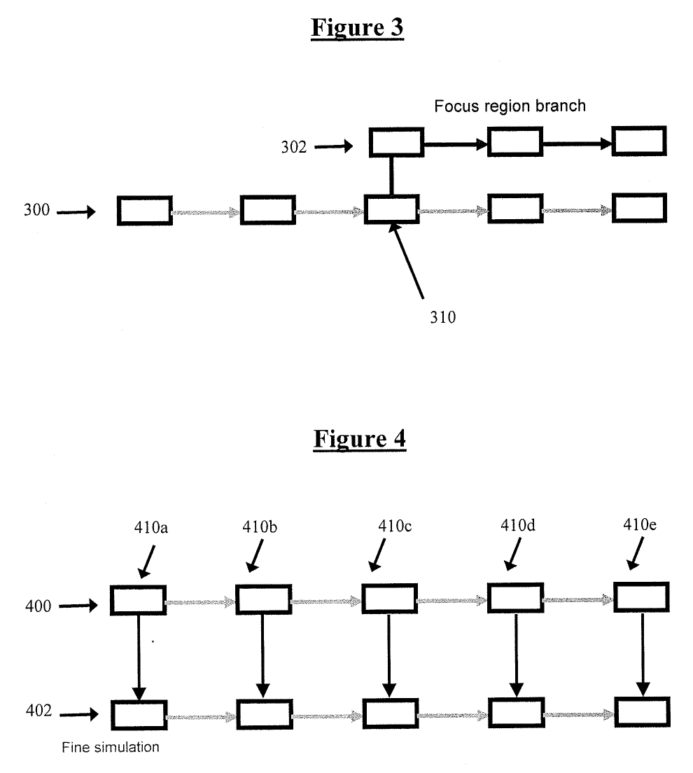

FIG. 3 illustrates simulation branching for a focus region. The main branch runs at the original resolution. At the breakpoint 310 it is desired to increase resolution near a chosen camera, and an appropriate graphical user interface (GUI) of software used to implement the present invention may be used to control the resolution modification. The focus region simulation branch 302 comprises a simulation running at higher resolution but only in the vicinity of the chosen camera location.

Such focus region branching addresses the need to be able to perform multiple simulations for different shots within a common simulation scene. The base simulation is performed at coarse resolution for all simulation elements in the scene. Frames of view or “cameras” are then located for the specific detailed shots. These are used to control the simulation resolution locally within the region of visibility from the selected camera. A suitable system state in the base or branched simulation is chosen reflecting the timing of the close up shot within the overall scene. A focus region branch is then created in the simulation state tree. Optionally simulation and visualisation controls can be changed at this point. A simulation is then run with the simulation resolution locally improved in the area of focus. Further branching can then be used for additional refinement of the focus region simulation. The simulation elements outside the view can be simulated at coarse resolution as part of the focus region simulation or they can be used from the stored system states of the underlying base or branched simulation.

FIG. 4 illustrates conversion of a low resolution simulation 400 into a high resolution simulation 402. In this arrangement key-framed motion can be applied for dynamic objects and/or control particle key-framed motion of fluid particles can be effected. The coarse resolution simulation 400 may have been previously concluded by carrying out iterative simulations, for example using branching as discussed in the preceding, or otherwise. Once the coarse resolution simulation produces the desired event, the editor wishes to output a high resolution simulation of that event without changing the event behaviour. This is achieved in this embodiment by using the initial conditions of the coarse simulation 400 to generate suitable initial conditions for the fine simulation 402. Moreover, multiple records 410 of the system state are obtained from the coarse resolution simulation 400 in accordance with the present invention. From each saved system state 410 controlling information is derived and used to influence the contemporaneous stage of the high resolution simulation 402. In this embodiment the controlling information comprises stored object motion of selected simulated objects in the first simulation 400, which is then used in the high resolution simulation 402 to specify location and orientation of corresponding moving objects at key moments during the simulated event.

The embodiment of FIG. 4 thus addresses the issue of the lack of reproducibility of physics based simulations when changing the solution resolution. In traditional physics based simulations all the control of the simulation is specified using the initial and boundary conditions or other controls specified at the start of the simulation, the time dimension is free and the solution state is changed by solving some governing equation with a time stepping process. In contrast, the present embodiment considers the full solution over both space and time as an entire entity to be controlled and manipulated, rather than as a series of evolving sequential states. The underlying base or coarse solution 400 is used to automatically specify a spatially and time varying control for the entire solution 402 to ensure that it remains close to the original solution 400. The physics based simulation 402 is used only to generate the fine details that are desired at the fine resolution scale, but is not allowed to control the coarse level dynamics established by simulation 400. Control of the coarse level solution structure is still governed by the pre-existing coarse resolution base simulation 400. In alternative embodiments, other methods for ensuring that the fine simulation 402 remains consistent with the base simulation 400 may be used within the scope of the present invention. Not exhaustively these mechanisms include:
1. Converting object motion (trajectory and orientation) from being dynamic (moving in response to the simulation forces) to being key frame input data for the fine simulation. This is done by storing the object motion from the coarse simulation and using this to specify the location and orientation of moving objects in the fine resolution. This ensures that visually critical elements such as the positions and orientations of objects are guaranteed to be consistent with the base simulation.
2. Converting the coarse base solution into a time and spatially varying attractor or drag force that is coupled to the motion of fluid and/or particle elements in the fine solution. This coupling force ensures that the coarse scale structure of the fine simulation is consistent with the structure of the original coarse scale solution. This coupling can be via control particles or by forces generated from data stored on grid or other structures. The user can control the strength of the coupling and so control how rigidly the fine resolution solution matches the coarse scale solution

The simulation workflow management concepts of the present invention are thus designed to significantly reduce the costs and development time for visual effects created from physics based simulation.

In a preferred embodiment of the invention, the above four described capabilities namely restarts, branching, focus areas and rapid prototyping are all managed by a single GUI framework consisting of a timeline indicating the simulation duration. On this timeline there can be several user defined and selectable “system states” that could be used for modifying the simulation. The software includes a “Run” command for each branch, providing the ability to select and run each branch independently. Further, the user can edit all input parameters for each system state. The software also prevents re-execution of a parent or child branch while a simulation is running, to prevent over-writing results, and further provides for archiving and de-archiving of individual branches.

Some portions of this detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

As such, it will be understood that such acts and operations, which are at times referred to as being computer-executed, include the manipulation by the processing unit of the computer of electrical signals representing data in a structured form. This manipulation transforms the data or maintains it at locations in the memory system of the computer, which reconfigures or otherwise alters the operation of the computer in a manner well understood by those skilled in the art. The data structures where data is maintained are physical locations of the memory that have particular properties defined by the format of the data. However, while the invention is described in the foregoing context, it is not meant to be limiting as those of skill in the art will appreciate that various of the acts and operations described may also be implemented in hardware.

It should be borne in mind, however, that all of these and similar terms are to be associated with the appropriate physical quantities and are merely convenient labels applied to these quantities. Unless specifically stated otherwise as apparent from the description, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

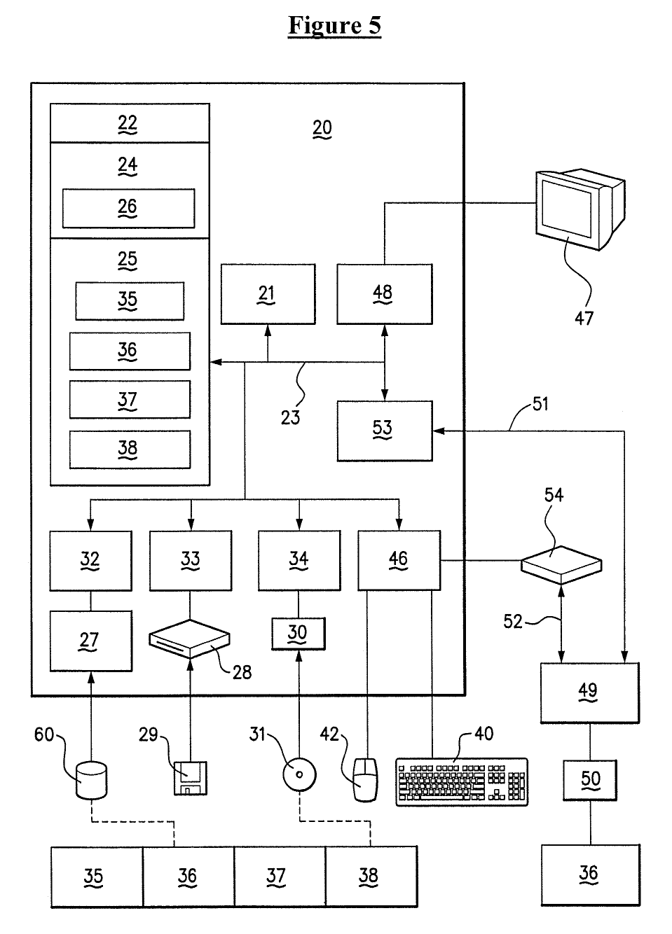

Turning to FIG. 5 the invention is illustrated as being implemented in a suitable computing environment. Although not required, the invention will be described in the general context of computer-executable instructions, such as program modules, being executed by a personal computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multi-processor systems, microprocessor-based or programmable consumer electronics, network PCs, minicomputers, mainframe computers, and the like. The invention may be practiced in distributed computing environments where tasks are performed by remote processing devices that are linked through a communications network. In a distributed computing environment, program modules may be located in both local and remote memory storage devices.

In FIG. 5 a general purpose computing device is shown in the form of a conventional personal computer 20, including a processing unit 21, a system memory 22, and a system bus 23 that couples various system components including the system memory to the processing unit 21. The system bus 23 may be any of several types of bus structures including a memory bus or memory controller, a peripheral bus, and a local bus using any of a variety of bus architectures. The system memory includes read only memory (ROM) 24 and random access memory (RAM) 25. A basic input/output system (BIOS) 26, containing the basic routines that help to transfer information between elements within the personal computer 20, such as during start-up, is stored in ROM 24. The personal computer 20 further includes a hard disk drive 27 for reading from and writing to a hard disk 60, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer readable instructions, data structures, program modules and other data for the personal computer 20. Although the exemplary environment shown employs a hard disk 60, a removable magnetic disk 29, and a removable optical disk 31, it will be appreciated by those skilled in the art that other types of computer readable media which can store data that is accessible by a computer, such as magnetic cassettes, flash memory cards, digital video disks, Bernoulli cartridges, random access memories, read only memories, storage area networks, and the like may also be used in the exemplary operating environment.

A number of program modules may be stored on the hard disk 60, magnetic disk 29, optical disk 31, ROM 24 or RAM 25, including an operating system 35, one or more applications programs 36, other program modules 37, and program data 38. A user may enter commands and information into the personal computer 20 through input devices such as a keyboard 40 and a pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port or a universal serial bus (USB) or a network interface card. A monitor 47 or other type of display device is also connected to the system bus 23 via an interface, such as a video adapter 48. In addition to the monitor, personal computers typically include other peripheral output devices, not shown, such as speakers and printers.

The personal computer 20 may operate in a networked environment using logical connections to one or more remote computers, such as a remote computer 49. The remote computer 49 may be another personal computer, a server, a router, a network PC, a peer device or other common network node, and typically includes many or all of the elements described above relative to the personal computer 20, although only a memory storage device 50 has been illustrated. The logical connections depicted include a local area network (LAN) 51 and a wide area network (WAN) 52. Such networking environments are commonplace in offices, enterprise-wide computer networks, intranets and, inter alia, the Internet.

When used in a LAN networking environment, the personal computer 20 is connected to the local network 51 through a network interface or adapter 53. When used in a WAN networking environment, the personal computer 20 typically includes a modem 54 or other means for establishing communications over the WAN 52. The modem 54, which may be internal or external, is connected to the system bus 23 via the serial port interface 46. In a networked environment, program modules depicted relative to the personal computer 20, or portions thereof, may be stored in the remote memory storage device. It will be appreciated that the network connections shown are exemplary and other means of establishing a communications link between the computers may be used.

It will be appreciated by persons skilled in the art that numerous variations and/or modifications may be made to the invention as shown in the specific embodiments without departing from the scope of the invention as broadly described. The present embodiments are, therefore, to be considered in all respects as illustrative and not restrictive.

1. A method for simulation workflow management, the method comprising:
executing a first simulation;
during the first simulation, making a record of the system state of the first simulation as it exists at a point in time; and
executing a second simulation using at least a portion of the recorded system state as input conditions for the second simulation.

2. The method of claim 1, further comprising making a record of the system state of the first simulation at multiple points in time throughout the simulation, referred to as breakpoints.

3. The method of claim 1, further comprising branching the first simulation at a breakpoint by using at least a portion of the recorded system state of that breakpoint and revised user control parameters as initial conditions to initiate the second simulation.

4. The method of claim 1, further comprising making a record of the system state of the second simulation as it exists at one or more breakpoints separated in time, to effect multiple breakpoints and multiple branching steps in the simulation workflow process.

5. The method of claim 1 wherein the second simulation comprises a focus region simulation of a portion of a wider event simulated by the first simulation.

6. The method of claim 1, further comprising using the recorded system state of each breakpoint of a coarse resolution first simulation to provide controlling information to contemporaneous moments in the simulated event during execution of a second high resolution simulation.

7. A computer program element comprising computer program code means to make a computer execute a procedure for simulation workflow management, the computer program element comprising:
computer program code means for executing a first simulation;
computer program code means for, during the first simulation, making a record of the system state of the first simulation as it exists at that point in time; and
computer program code means for executing a second simulation using at least a portion of the recorded system state as input conditions for the second simulation.

8. The computer program element of claim 7, further comprising computer program code means for making a record of the system state of the first simulation at multiple points in time throughout the simulation, referred to as breakpoints.

9. The computer program element of claim 7, further comprising computer program code means for branching the first simulation at a breakpoint by using at least a portion of the recorded system state of that breakpoint and revised user control parameters as initial conditions to initiate the second simulation.

10. The computer program element of claim 7, further comprising computer program code means for making a record of the system state of the second simulation as it exists at one or more breakpoints separated in time, to effect multiple breakpoints and multiple branching steps in the simulation workflow process.

11. The computer program element of claim 7 wherein the second simulation comprises a focus region simulation of a portion of a wider event simulated by the first simulation.

12. The computer program element of claim 7, further comprising computer program code means for using the recorded system state of each breakpoint of a coarse resolution first simulation to provide controlling information to contemporaneous moments in the simulated event during execution of a second high resolution simulation.

13. A method for high resolution simulation, the method comprising:
optimising a first physics based simulation carried out at low resolution; and
recording event controlling information at a plurality of points in time throughout the first simulation; and
executing a second simulation at high resolution based on initial conditions of the first simulation, and further based on the contemporaneous controlling information.

14. The method of claim 13 wherein the controlling information comprises stored object motion of selected simulated objects in the first simulation, the method further comprising using the controlling information in the high resolution simulation to specify location and orientation of corresponding moving objects at key moments during the simulated event.

15. The method of claim 13 wherein the controlling information comprises a spatially varying attractor or drag force derived from the first simulation at the selected points in time, the method further comprising using the controlling information in the second simulation to ensure the coarse scale structure of the event is consistent with the first simulation while allowing high resolution simulation of fine detail in the second simulation.

16. A computer program element comprising computer program code means to make a computer execute a procedure for high resolution simulation, the computer program element comprising:
computer program code means for optimising a first physics based simulation carried out at low resolution; and
computer program code means for recording event controlling information at a plurality of points in time throughout the first simulation; and
computer program code means for executing a second simulation at high resolution based on initial conditions of the first simulation, and further based on the contemporaneous controlling information.

17. The computer program element of claim 16 wherein the controlling information comprises stored object motion of selected simulated objects in the first simulation, the computer program element further comprising computer program code means for using the controlling information in the high resolution simulation to specify location and orientation of corresponding moving objects at key moments during the simulated event.

18. The computer program element of claim 16 wherein the controlling information comprises a spatially varying attractor or drag force derived from the first simulation at the selected points in time, the computer program element further comprising computer program code means for using the controlling information in the second simulation to ensure the coarse scale structure of the event is consistent with the first simulation while allowing high resolution simulation of fine detail in the second simulation.
